(19) United States
(12) Patent Application Publication
(10) Pub. No.: US 2019/0350211 A1
(43) Pub. Date: Nov. 21, 2019

(54) FOODSTUFF PREPARATION DEVICE AND METHOD

(71) Applicant: Kevin Paul Harrison, Norwich (GB)

(72) Inventor: Kevin Paul Harrison, Norwich (GB)

(21) Appl. No.: 16/412,813

(22) Filed: May 15, 2019

(30) Foreign Application Priority Data
May 15, 2018 (GB) 1807875.8

(51) Int. Cl. A21C 15/00; B26B 27/00

(52) U.S. Cl. CPC A21C 15/007; A21D 13/32; B26B 27/00

(57) ABSTRACT

A foodstuffs preparation device suitable for preparing breadstuff-based goods, the device comprises a hollow cylindrical tube having an open first end, a second end and a side wall, the side wall defining a tube channel, the first end including a cutting arrangement, the side wall defining an elongate aperture with an anterior end proximal to the first end and a posterior end distal from the first end, wherein the aperture is suitable for the insertion of a foodstuff into the tube channel.

### TECHNICAL FIELD

The current invention relates to a device and method for preparing a foodstuff, for example, and primarily a breadstuff, and in particular those breadstuffs in the form of a baguette or the like.

### BACKGROUND

Sandwiches are one of the most popular and widely consumed foodstuffs and are sold, almost ubiquitously, all around the world. Although there is now a multitude of variations, traditionally, sandwiches consist of two slices of bread or alternative breadstuffs, with a sandwich filling enclosed therebetween. However, as all sandwich eaters will have experienced, this configuration has its drawbacks. Firstly, the open design requires the use of two hands to hold the sides of the sandwich and try to prevent its fillings from falling out. This reduces the ability of the eater to perform other activities which require the use of hands, such as computer work or recreational activities such as playing cards or reading.

Second, most sandwiches consist of at least one fluid or semi-fluid element which can easily leak from the open edges of the sandwich, due to gravity or the pressure created when biting into the sandwich. Not only does this decrease the quality of the sandwich, which has now altered its ratio of solid to fluid elements, but these fluid elements can also land on clothing or furniture, producing unwanted stains.

Combined, these features limit the sandwich to controlled and often sanitary environments where the risk of spillage can be reduced and is less detrimental should it occur. Furthermore, in the modern era and the widespread increase in time pressures, the inability to eat on the move without the risk of spilling fluids on one's clothing is a considerable drawback.

Certain sandwiches, such as those made using baguettes or batons, seek to overcome the chances of spillage by only cutting along one edge of the baguette, leaving the opposite edge intact as a barrier. However, in biting such sandwiches the increase in pressure almost inevitably causes the filling to be squeezed out of the one cut edge and exit the sandwich.

The current invention seeks to overcome at least the above limitations.

### BRIEF SUMMARY

In a first broad independent aspect, the invention provides a foodstuffs preparation device suitable for preparing breadstuff-based goods, the device comprising a hollow cylindrical tube having an open first end, a second end and a side wall, the side wall defining a tube channel, the first end including a cutting arrangement, the side wall defining an elongate aperture with an anterior end proximal to the first end and a posterior end distal from the first end, wherein the aperture is suitable for the insertion of a foodstuff into the channel.

This configuration is particularly advantageous because the cutting edge allows easy insertion of the device into the breadstuff, with minimal force required. The aperture within the side wall provides the user with easy access into the device channel. This not only allows the user to remove the column of removed breadstuff with ease but also allows the user to insert foodstuffs, such as sandwich fillings, which can then be easily inserted into the created cavity. Furthermore, it enables the user to create a sandwich where the ingredients are evenly distributed along the sandwich. The user can form the distinct filling ratios and patterns of fillings within the channel as desired and then use the device to insert the fillings into the sandwich as arranged.

Optionally, the second end of the tube is open allowing access to the channel. This is advantageous because it assists in preventing a pressure build up within the device as it is inserted into the breadstuff.

Optionally, the cutting arrangement incorporates cuspate teeth.

Optionally, the cutting arrangement is serrated.

Optionally, the device further comprises a plunger at least partially housed within the channel proximal to the second end of the tube. This is advantageous because it pushes ingredients within the device out of the opening in a fast and efficient manner.

Optionally, the second end includes a handle. This is advantageous because it provides the user with a location to grip the device during operation. Further optionally, the handle comprises a plurality of ridged or grooved portions. This is advantageous because it improves the user's grip on the device, reducing the chances that the grip will slip during operation.

Optionally, the device further including a cover mounted in sliding engagement with the tube and moveable between a first position wherein the aperture is open and a second position in which the aperture is covered, wherein upon actuation the cover moves relative to the aperture in a first axis. This is particularly advantageous firstly because it allows the user to close the aperture when not in use, preventing dust and other dirt from falling into the device channel. Secondly, the sliding cover informs the user of the quantity of fillings required to occupy the cavity created in the breadstuff. Further optionally, the cover is actuable by applying force to a flange attached to the cover. Further optionally, at least a portion of the cover is housed within the channel. Further optionally, at least a portion of the cover is external to the channel. Further optionally, the cover further comprising an annular body in fixed engagement with the cover and housed within the channel. This is particularly advantageous because it enables the user to push ingredients contained within the device channel, out of the device simply by moving the cover. Yet further optionally, the annular body has a diameter substantially equal to the channel.

Optionally, the device further comprises an elongate tool in flexible attachment with the side wall, the tool suitable for insertion into the channel of the device

In a second broad independent aspect, the invention provides a method of preparing a breadstuff-based foodstuff such as a baguette or the like, the method comprising the steps of taking a hollow cylindrical tube with an open first end, a second end and a side wall, the side wall defining a channel, pressing a cutting arrangement incorporated at the first end of the tube against a suitable breadstuff, applying force to the device to drive the device into the breadstuff to the desired depth, retracting the device from the breadstuff along with bread retained within the channel, removing the bread from the channel, inserting fillings into the channel via the aperture, pushing the fillings out of the first end of the tube and into a breadstuff cavity.

This is particularly advantageous because it enables the user to create a baguette sandwich or similar, in a quick and easy manner. By inserting the ingredients into the device before inserting them into the breadstuff, it reduces the amount of mess is reduced and the associated awkwardness of attempting to push ingredients into the small aperture of a channel. Furthermore, it enables the user to create a sandwich where the ingredients are evenly distributed along the sandwich. The user can form the distinct filling ratios and patterns of fillings within the channel as desired and then use the device to insert the fillings into the sandwich as arranged.

Optionally, the cutting arrangement incorporates cuspate teeth.

Optionally, the cutting arrangement is serrated.

Optionally, the method includes the step of applying a rotational force around the axis of the device when driving the device into the breadstuff.

Optionally, further incorporating a cover mounted in sliding engagement with the tube, wherein when driving the device into the foodstuff the cover is actuated to move relative to the aperture along the axis of the device. This is particularly advantageous firstly because it allows the user to close the aperture when not in use, preventing dust and other dirt from falling into the device channel. Secondly, the sliding cover informs the user of the quantity of fillings required to occupy the cavity created in the breadstuff.

Optionally, the cover is actuated by contact of the cover with the breadstuff preventing its movement into the breadstuff.

Optionally, a portion of the cover is housed within the channel.

Optionally, at least a portion of the cover is external of the channel.

Optionally, the method includes the step of actuating the cover such that an annular body attached to the cover and housed within the channel pushes fillings out of the channel. This is particularly advantageous because it enables the user to push ingredients contained within the device channel, out of the device simply by moving the cover.

Optionally, the method includes the step of selecting a tool, inserting the tool into the channel and pushing bread and fillings out of the channel.

Optionally, the tool is in flexible attachment with the device.

### BRIEF DESCRIPTION OF THE DRAWINGS

FIG. 1 shows a portion of a first embodiment of a foodstuff preparation device in perspective view;

FIG. 2 shows a second embodiment of the a foodstuff preparation device in perspective view, in use;

FIG. 3 shows a third embodiment of the a foodstuff preparation device in perspective view, in use;

FIG. 4 illustrates a fourth embodiment of a foodstuff preparation device; and

FIGS. 5a-5c are cross-sectional views of sections A-A, B-B and C-C.

### DETAILED DESCRIPTION

With reference to the above drawings, the following detailed description provides an understanding of the present invention. The invention comprises a device and a method suitable for removing the center from, and then subsequently filling a baked good, such as a French baguette. The following description will make reference to the use of the device only with regard to a baguette; however, it should be understood that this is by way of example only and the invention is in no way limited as such. The invention is suitable for use with a range of baked goods, and further embodiments also envisage the use of the invention with alternative food stuffs, such as cucumbers or aubergines. Because of the size of the disclosed device, the device is wholly unsuitable for use on fruit and vegetables such as apples. It should also be understood that any references to fillings or sandwich fillings, should be considered to represent any suitable foodstuffs.

To provide clarity, the components of the invention which are common to each figure have retained identical numerical references throughout all figure descriptions.

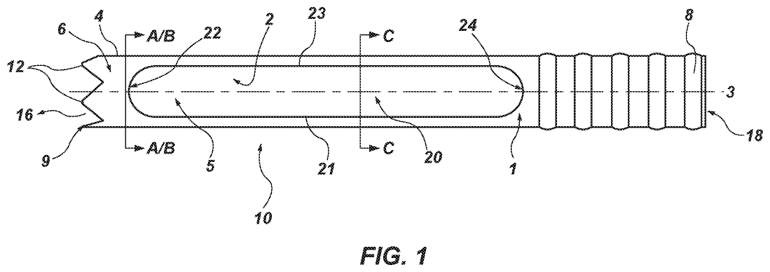

FIG. 1 shows a first embodiment of a foodstuff preparation device 10 in perspective view. The device 10 has a substantially cylindrical wall 4 having a main axis 3. The wall 4 has an outer surface 1 and an inner surface 2. The inner surface 2 defines a cylindrical channel 5 centered around the axis 3. In an embodiment, the channel 5 is a continuous through-channel, having an anterior opening 16 and a posterior opening 18. In an alternative embodiment, the channel 5 is closed at the posterior end 8 of the device 10.

The wall 4 at the anterior end 6 of the device 10, incorporates a cutting arrangement 9. The cutting arrangement 9 allows the device 10 to cut through the flesh of the baguette, particularly if a twisting motion is applied to the device 10 during the cutting action. In the current embodiment, the cutting arrangement 9 is a series of axially extending cuspate, or saw-tooth, portions 12 continuously formed with and extending from, the wall 4. In an alternative embodiment, the cuspate portions 12 are connected to the wall 4 by a suitable means known in the art such as a push fit connection, bolts, catches or adhesive. The cuspate portions 12 can be provided such that they are sharper along one of the faces of each of the cuspate portions 12, so providing a right- or left-handedness to the device 10.

In a further alternative embodiment, the cutting arrangement 9 incorporates a blade or serrated edge. In an embodiment, the cutting arrangement 9 is permanently affixed to the wall 4 of the device 10. In an alternative embodiment, the cutting arrangement 9 is detachably mounted to the wall 4 with the benefit that it can be replaced with a new cutting arrangement 9 should the original become blunted or broken during use.

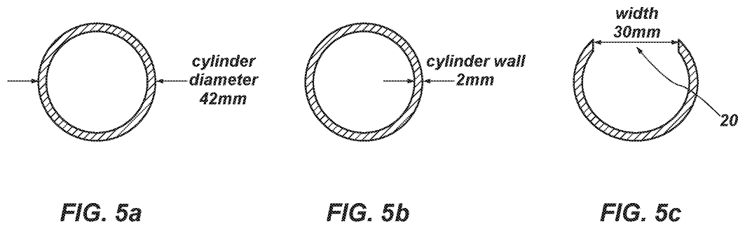

The wall 4 of the device 10 incorporates defines an elongate through-aperture 20 extending axially along the wall 4 parallel to the axis 3. The aperture 20 provides a passage through the device 10, from the outer surface 1 of the wall 4, to the channel 5. The aperture 20 has a first end 22 proximal to the anterior end 6 of the device 10, and a second end 24 proximal to the posterior end 8 of the device 10. The aperture 20 has long edges 21 and 23 which extend axially parallel to one another, before converging at first and second ends 22 and 24 at the anterior and posterior of the aperture respectively. In the embodiment of FIG. 1 the long edges 21 and 23 converge together to form a continuous curve at both the anterior and posterior end of the aperture 20. In an alternative embodiment, the long edges 21 and 23 remain parallel, with the anterior and posterior ends of the aperture 20 defined by curved edges perpendicular to the long edges 21 and 23. As shown in the cross-sectional view of FIG. 5c the width of the aperture 20 is around 30 mm which allows the filling to readily be passed into the interior of the device 10. The height of the wall 4 along the long edges 21 and 23 are such that approximately the same volume of filling can be added as the volume of breadstuff removed. Typically the wall 4 extends 70% or more of the circumference of the device 10 and preferably 75-85% and further preferably around 80%, to prevent filling from overflowing the long edges 21 and 23 prior to insertion not the hollowed breadstuff.

The aperture 20 provides access to the channel 5, allowing the user to easily add to or remove ingredients from the channel 5. For example, in use, the user pushes the anterior end 6 of the device 10 into the baguette, utilizing the cutting arrangement 9 to make an incision into the bread. The severed bread enters the channel 5 via the anterior opening 16 of the device 10. After insertion into the baguette to the desired depth, the user withdraws the device 10 from the baguette, with the column of severed bread occupying retained within the channel 5. The aperture 20 allows access to the channel 5 enabling the user to push the column of bread back out of the channel 5 via the anterior opening 16. Upon removal of the bread, the user inserts fillings through the aperture 20 and into the channel 5. The anterior end 6 of the device 10 is reinserted into the cavity of the baguette—formed from the initial insertion and removal of the device 10—and the fillings are pushed or moved along the channel 5, out of the anterior opening 16 and into the baguette cavity. In the embodiment of FIG. 1, a tool, not included with the device 10, such as a fork, spoon or finger can be inserted into the channel 5 via the aperture 20 and used to push the fillings along the channel 5 and out of the anterior opening 16. The width of the aperture 20 is defined as the linear distance between the long edges 21 and 23.

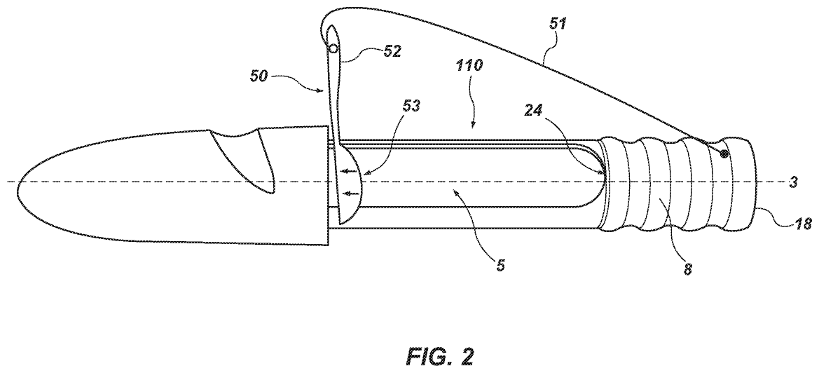

FIG. 2 shows a second embodiment of a foodstuff preparation device 110 in perspective view, in use. The device 110 is shown with positioned such that the anterior end 6 is inserted into a baguette. In the embodiment of FIG. 2, the device 110 includes a tool 50, attached to the device 110. The tool 50 is designed for removing the column of bread, removed from the baguette, from the channel 5 and subsequently for aiding in pushing fillings from the channel 5 into the hollowed baguette. In the illustrated exemplary embodiment, the tool 50 has a handle 52 attached to a head 53. In a preferred embodiment, the head 53 is substantially round, with a radius of curvature substantially equal to that of the inner surface 2 of the wall 4 (see FIG. 1). The diameter of the head 53 is less than the cross-sectional diameter of the channel 5, such that the head 53 can move within the channel 5 along the axis 3. In a preferred embodiment, the head 53 is planar. In an alternative embodiment, the head 53 can be any one of convex, concave or have a waved conformation. In an embodiment, the tool 50 is attached to the device 110 by a cord 51. The cord 51 can be formed from one or more of a plastic, metal, fibrous or other material known in the art to be suitable for use with foodstuffs and especially hot foodstuffs.

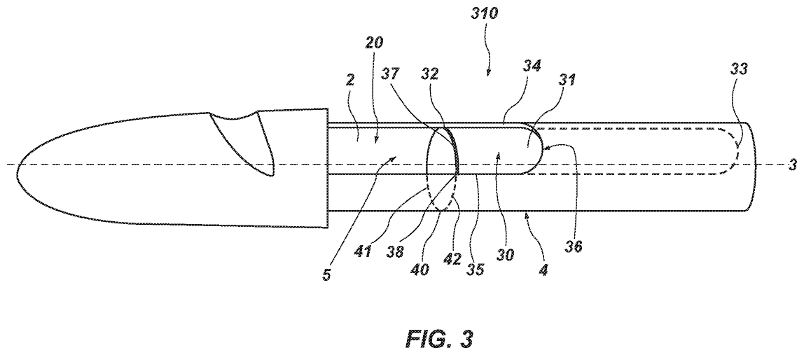

FIG. 3 shows a third embodiment of a foodstuff preparation device 310 in perspective view, in use. The device 310 has an integral cover 30 extending across the internal side of the aperture 20 preventing access to the channel 5. The cover 30 incorporates an arched portion 31, and a flange 32. The arched portion 31 defines a continuous arcuate surface 36, curving from the edge 34 to the edge 35 around the axis 3. The arched portion 31 has a radius of curvature smaller than that of the inner surface 2 of the device 310, such that, in use, the surface of the arched portion 31 is in continuous frictional contact with the inner surface 2 of the wall 4. The linear distance between the edges 34 and 35 of the arched portion 31 is equal to the width of the aperture 20, such that, in a closed configuration, the arched portion 31 completely covers the width of the aperture 20. The distance between the posterior edge 33 of the arched portion 31 and the flange 32 is equal to the distance between first and second ends 22 and 24 of the aperture 20 (see FIG. 1). In a first instance, the cover 30 acts to block access to the channel 5 when not in use, preventing dust and dirt from falling into the channel 5. In a second instance, the cover 30 acts to indicate the volume of fillings that should be inserted into the channel 5 to appropriately fill the cavity left in the baguette after insertion and removal of the device 310. The mechanism by which the cover 30 achieves this is explained below.

The flange 32 is attached at the anterior end of the arched portion 31. In one embodiment, the flange 32 has a radius of curvature equal to that of the arched portion 31. The width of the flange 32, defined as the linear distance between points 37 and 38, is greater than the width of the aperture 20. This is beneficial because, in use, it prevents the flange 32 from passing through the aperture 20 into the channel 5. The points 37 and 38 of the flange 32 rest on the long edges 21 and 23 (as shown in FIG. 1) of the aperture 20.

The cover 30 is mounted on and in sliding engagement with the device 310 such that the cover 30 can be moved in the direction of the axis 3. In use, the cover 30 is initially in a closed position, the flange 32 is proximal to the anterior first end 22 resting upon edges 21 and 23 of the aperture 20 (see FIG. 1). The arched portion 31 of the cover 30, extends axially from the flange 32 towards the posterior end 8 of the device 310, parallel to the axis 3. The arched portion 31 is housed within the channel 5, the posterior edge 33 extending posterior to the second end 24 of the aperture 20 (see FIG. 1). In this configuration, the arched portion 31 prevents access to the channel 5 via the aperture 20.

During use of the device in accordance with this embodiment, the user pushes the anterior end 6 (see FIG. 1) of the device 310 into the baguette, utilizing the cutting arrangement 9 (FIG. 1) to make an incision into the bread. As the device 310 is inserted into the baguette, the bread around the outside of the device 310 makes contact with the flange 32 causing the cover 30 to move relative to the device 310. As a result, the cover 30 moves along the aperture 20 in a posterior direction. When the device 310 is removed from the baguette, the cover 30 remains in in its location relative to the device 310 and thus acts as a measure of the depth of the cavity created in the baguette. Furthermore, due to the correlation between the size of the channel 5 and the size of the cavity created by the device 310, the portion of the channel 5 accessible by the aperture 20 indicates the quantity of fillings required to fill the cavity. In an embodiment, the outer surface 1 of the wall 4 (see FIG. 1) provides an indication of the dimensions of the cavity created in the baguette and therefore the quantities of fillings required. This could include but is not limited to, values indicating distance or volume.

In a further embodiment, the inner surface 2 of the wall 4 (see FIG. 1) incorporates brackets suitable for accommodating the edges 34 and 35 of the arched portion 31. In use, these brackets assist with the sliding motion of the cover 30 across the aperture 20. In a further alternative embodiment, the cover 30 has dimensions greater than the circumference of the inner surface 2 of the wall 4. The cover 30 is mounted externally of the device 310 in frictional contact with the outer surface 1 of the wall 4 (see FIG. 1).

In an alternative embodiment, the cover 30 incorporates a disk 40 attached to the flange 32, and oriented as shown in FIG. 3, with planar faces 41 and 42 perpendicular to the axis 3 and the edge 34. The disk 40 is substantially round, with a radius of curvature smaller than that of the inner surface 2 of the wall 4 (see FIG. 1), such that the disk 40 is in frictional contact with the inner surface 2. The diameter of the disk 40 is less than the cross-sectional diameter of the channel 5. In use, the disk is housed within the channel 5, perpendicular to the axis 3. During the removal of the center of a baguette, the material removed pushes against the face 41 of the disk 40, moving the cover 30 along the aperture 20 relative to the device 310. After the bread has been removed from the channel 5 and the fillings have been placed in the channel 5 via the aperture 20, the user can move the cover 30 along the aperture 20 towards the anterior end 6 (not shown) of the device 310. The face 41 of the disk 40 contacts the filling or fillings within the channel 5, pushing the fillings through the channel 5, out of the anterior opening 16 (see FIG. 1) and into the baguette.

In an alternative optional embodiment, the device 410 includes a plunger housed at the posterior end 8 of the channel 5. Actuation of the plunger pushes a piston through the channel 5 from the posterior end 8 to the anterior end 6 (see FIG. 1). In use, the plunger will push fillings within the channel 5 out of the anterior opening 16 (see FIG. 1) and into the hollowed baguette.

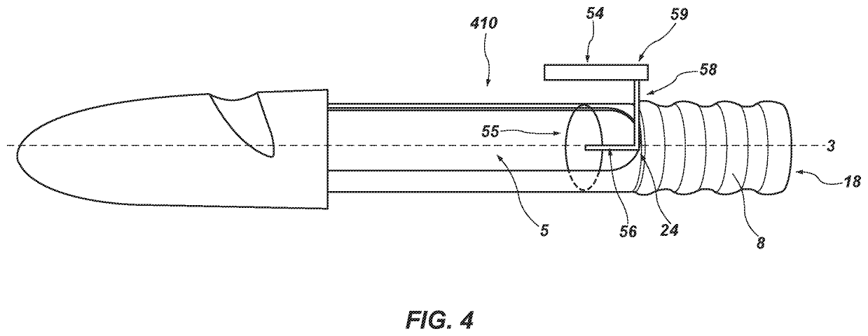

In a further embodiment of device shown in FIG. 4, the device 410 has an anterior end 6 (see FIG. 1) which is inserted into a baguette. The device 410 includes a tool 54 to aid in moving a filling into a baguette.

The tool 54 has a disc-shaped head 55 and is designed to be a sliding fit along the axis 3 of the device 410. After the bread has been removed through the channel 5, the tool 54 is placed into the channel 5 with the upright bar 58 against the second end 24. The disc-shaped head 55 then acts as a barrier to stop foodstuffs and fillings passing the second end 24 into the posterior end 8. After foodstuffs and fillings are added to the device 410 through the channel 5, the user then holds the handle 59 of the tool 54 and pulls it along the axis 3 of the device 410 towards the baguette whilst holding the baguette with their other hand. When upright the bar 58 of the tool 54 comes into contact with the baguette, the user whilst still holding the handle 59 of the tool 54 then grips the handle on the posterior end 8 of the device 410. The device 410 is then slowly extracted from the baguette whilst holding the tool 54 in place causing the upright bar 58 to come into contact with the first end 22 (see FIG. 1). The length of the stem 56 of the tool 54 is such that when the upright bar 58 contacts the first end 22, the disc 55 is now perpendicular with the cuspate portions 12. When the device 410 and the tool 54 are fully removed from the baguette, all foodstuffs and fillings have been inserted into the baguette. The tool 54 can be formed from one or more of a plastic, metal or other material known in the art to be suitable for use with foodstuffs, hot or cold, solid or fluid.

In a preferred embodiment, the device 10 is made from polymeric material. In an embodiment, the device 10 is made in a single piece by injection molded plastics. The cover 30 (see FIG. 3) is formed as a separate piece by injection molded plastics. In a preferred embodiment, the device 10 and/or the cover 30 (see FIG. 3) are formed of a hydrophobic material to prevent foodstuffs and bacterial colonies from sticking to the surfaces. Being hydrophobic makes the device easier to clean and more hygienic. In an alternative embodiment, the device 10 can be made of metal, glass or Perspex®.

In an embodiment, the posterior end 8 of the device 10 (see FIG. 1) incorporates a handle to increase user comfort and assist with insertion of the device into the baguette. In alternative embodiment, the posterior end 8 of the device 10 incorporates regions having an increased coefficient of friction, assisting the user in maintaining grip on the device 10 during use.

In the embodiments of FIGS. 1, 2 and 3, the wall 4 has a circular transverse cross-section. In an alternative embodiment, the transverse cross-section of the wall 4 can be any one of; elliptical, square, triangular, rectangular, pentagonal, hexagonal, octagonal, or teardrop shaped.

In an embodiment, the device 10 is between about 60 cm and 15 cm in length. In an alternative embodiment, the device 10 is between about 50 cm and 20 cm in length. In an alternative embodiment, the device 10 is between about 40 cm and 20 cm in length.

In an embodiment, the channel 5 within the device 10, has an outer diameter of between 1 cm and 5 cm. In an alternative embodiment, the channel 5 within the device 10, has a diameter of between 2 cm and 5 cm. In an alternative embodiment, the channel 5 within the device 10, has an outer diameter of between 2 cm and 4 cm. In a preferred embodiment the outer diameter is 42 mm.

The wall of the device is of thickness to suit the type of breadstuff being acted upon. A typical thickness is from 1-4 mm and, as exemplified, 2 mm is a preferred value.

1. A foodstuffs preparation device suitable for preparing breadstuff-based goods, the device comprising a hollow cylindrical tube having an open first end, a second end and a side wall, the side wall defining a tube channel, the first end including a cutting arrangement, the side wall defining an elongate aperture with an anterior end proximal to the first end and a posterior end distal from the first end, wherein the aperture is suitable for an insertion of a foodstuff into the tube channel.

2. A device according to claim 1, wherein the second end of the tube is open allowing access to the tube channel.

3. A device according to claim 1, wherein the cutting arrangement incorporates cuspate teeth.

4. A device according to claim 1, wherein the cutting arrangement is serrated.

5. A device according to claim 1, further comprising a plunger at least partially housed within the tube channel proximal to the second end of the tube.

6. A device according to claim 1, wherein the second end includes a handle.

7. A device according to claim 6, wherein the handle comprises a plurality of ridged or grooved portions.

8. A device according to claim 1, further including a cover mounted in sliding engagement with the tube and moveable between a first position wherein the aperture is open and a second position in which the aperture is covered, wherein upon actuation the cover moves relative to the aperture in a first axis.

9. A device according to claim 8, wherein the cover is actuable by applying force to a flange attached to the cover.

10. A device according to claim 8, wherein at least a portion of the cover is housed within the tube channel.

11. A device according to claim 8, wherein at least a portion of the cover is external to the tube channel.

12. A device according to claim 8, further comprising an annular body in fixed engagement with the cover and housed within the tube channel.

13. A device according to claim 12, wherein the annular body has a diameter substantially equal to the tube channel.

14. A device according to claim 1, further comprising an elongate tool in flexible attachment with the side wall, the tool suitable for insertion into the tube channel of the device.

15. A method of preparing a breadstuff-based foodstuff such as a baguette or the like, the method comprising the steps of taking a hollow cylindrical tube with an open first end, a second end and a side wall, the side wall defining a tube channel, pressing a cutting arrangement incorporated at the first end of the tube against a suitable breadstuff, applying force to a device to drive the device into the breadstuff to a desired depth, retracting the device from the breadstuff along with bread retained within the tube channel, removing the bread from the tube channel, inserting fillings into the tube channel via a aperture, pushing the fillings out of the first end of the tube and into a breadstuff cavity.

16. A method according to claim 15, wherein the cutting arrangement incorporates cuspate teeth.

17. A method according to claim 15, wherein the cutting arrangement is serrated.

18. A method according to claim 15, further including the step of applying a rotational force around an axis of the device when driving the device into the breadstuff.

19. A method according to claim 18, further incorporating a cover mounted in sliding engagement with the tube, wherein when driving the device into the foodstuff the cover is actuated to move relative to the aperture along the axis of the device.

20. A method according to claim 19 wherein the cover is actuated by contact of the cover with the breadstuff preventing its movement into the breadstuff.

21. A method according to claim 19, wherein at least a portion of the cover is housed within the tube channel.

22. A method according to claim 19, wherein at least a portion of the cover is external of the tube channel.

23. A method according to claim 19, including the steps of actuating the cover such that an annular body attached to the cover and housed within the tube channel pushes fillings out of the tube channel.

24. A method according to claim 15, further including the steps of selecting a tool, inserting the tool into the tube channel and pushing bread and fillings out of the tube channel.

25. A method according to claim 24, wherein the tool is in flexible attachment with the device.
